(19) United States
(12) Patent Application Publication
(10) Pub. No.: US 2026/0364998 A1
(43) Pub. Date: Nov. 19, 2026

(54) THERMAL MANAGEMENT SYSTEM FOR FUEL CELL ELECTRIC VEHICLE

(71) Applicants: Hyundai Motor Company, Seoul (KR); Kia Corporation, Seoul (KR)

(72) Inventors: Sangyeop Lee, Hwaseong-si (KR); Myung Hoe Kim, Hwaseong-si (KR); Yangbo Kang, Hwaseong-si (KR); Seung Ho Lee, Hwaseong-si (KR); Sang Ku Hur, Hwaseong-si (KR); Kwang Woon Cho, Hwaseong-si (KR); Kwangok Han, Hwaseong-si (KR)

(21) Appl. No.: 19/636,610

(22) Filed: Apr. 1, 2026

(30) Foreign Application Priority Data
May 13, 2025 (KR) 10-2025-0061697
Dec. 2, 2025 (KR) 10-2025-0187845

(51) Int. Cl. B60H 1/14; B60H 1/00; B60H 1/03

(52) U.S. Cl. CPC B60H 1/143; B60H 1/00278; B60H 1/00392; B60H 1/00885; B60H 1/034; B60H 2001/00307

(57) ABSTRACT

In an embodiment, a thermal management system is provided. The thermal management system includes a first coolant line through which a coolant is flowable, and a fuel cell stack, a radiator, and a water pump provided on the first coolant line. The thermal management system further includes a HVAC module including a heater core configured to be selectively supplied with a coolant. A second coolant line is connected to the first coolant line to selectively provide the coolant to the heater core, with the heater core being provided on the second coolant line. A cathode oxygen depletion (COD) heater is provided on the second coolant line on an upstream side of the heater core.

### CROSS-REFERENCE TO RELATED APPLICATIONS

This application claims priority to and the benefit of Korean Patent Application No. 10-2025-0061697 filed with the Korean Intellectual Property Office on May 13, 2025, and Korean Patent Application No. 10-2025-0187845 filed with the Korean Intellectual Property Office on Dec. 2, 2025, the entire contents of which are incorporated herein by reference.

### TECHNICAL FIELD

An embodiment relates to a thermal management system for a fuel cell electric vehicle, and more particularly, the present disclosure relates to a thermal management system for a fuel cell electric vehicle that uses a cathode oxygen depletion heater applied in order to heat the coolant supplied to a fuel cell stack for heating of the vehicle interior.

### BACKGROUND

A fuel cell stack is an energy conversion system that converts the chemical energy of fuel directly into electrical energy, by generating electrical power as part of a chemical reaction between electrolyte and gas of diesel or industrial fuel. Unlike general batteries, the fuel cell stack does not require recharging, and is a power generating system that may continuously generate electricity as long as fuel is supplied.

The fuel cell stack has an electrolyte and two electrodes overlapped like a sandwich, and when oxygen and hydrogen flow to the electrodes, electricity, heat, and water are generated. The fuel cell stack is used as a system for supplying power to electric vehicles or fields that are not practically utilized such as a spacecraft.

Various fuels such as natural gas, methanol, and gasoline may be used in the fuel cell stack, and the fuel is reformed into hydrogen using a fuel reformer prior to being used.

Meanwhile, with growing interest in energy efficiency and environmental pollution, it is expected that an electric vehicle using the fuel cell stack may substantially replace an internal combustion engine vehicle.

A fuel cell electric vehicle, which is environment-friendly, refers to a vehicle that uses a fuel cell as an electricity supply source, where the fuel cell generates electricity through an electrochemical reaction between hydrogen and oxygen, and the generated electricity drives a motor.

Such a fuel cell electric vehicle (FCEV) includes the fuel cell stack for generating electricity through a chemical reaction and a battery for storing electricity generated by the fuel cell stack.

Here, the fuel cell stack converts the chemical reaction energy of oxygen and hydrogen into electrical energy, and in this process, thermal energy is generated by chemical reactions within the fuel cell stack. Accordingly, effectively removing the generated heat is essential for ensuring the performance of the fuel cell stack.

Cooling and heating of the fuel cell stack and the battery may maintain a normal operation temperature. Here, the cooling and heating of the fuel cell stack and the battery may be achieved by the coolant circulating the fuel cell stack and the coolant circulating the battery, and the respective coolants may be supplied from a stack cooling apparatus and a battery cooling apparatus.

Meanwhile, the fuel cell electric vehicle includes a refrigerant circulation device that circulates a refrigerant to heat or cool the vehicle interior.

The refrigerant circulation device is configured to maintain an appropriate interior temperature of the vehicle regardless of changes in an external temperature to provide a comfortable interior environment. The refrigerant circulation device is configured to heat or cool the interior of the vehicle by heat-exchange through a condenser and an evaporator, in which a refrigerant discharged from the compressor circulates back to the compressor through the condenser, a receiver drier, an expansion valve, and the evaporator.

Accordingly, the fuel cell electric vehicle may have a stack cooling apparatus, a battery cooling apparatus, and an electrical component cooling apparatus for suppressing heat generation of the fuel cell stack, an electrical component, and the battery, and also with a thermal management system including a refrigerant circulation device for temperature adjustment of the vehicle interior.

In addition, in a conventional fuel cell electric vehicle, a refrigerant circulation device is used for cooling of the vehicle interior, and a coolant of a high temperature is used for heating the vehicle interior.

On the other hand, since the power generation of the fuel cell stack may not be smooth or the generated water can freeze when the temperature of the fuel cell stack is low, a cathode oxygen depletion (COD) heater for heating the coolant so as to rapidly increase the temperature of the fuel cell stack may be provided in a stack cooling apparatus.

However, such a conventional thermal management system for the fuel cell electric vehicle includes a heating apparatus for heating the vehicle interior by using the high temperature coolant is configured as a separate closed circuit, in addition to the stack cooling apparatus, the battery cooling apparatus, the electrical component cooling apparatus, and the refrigerant circulation device, and the thermal management of the fuel cell electric vehicle becomes inefficient because those component apparatus are not thermally interlinked.

In addition, a conventional thermal management system for the fuel cell electric vehicle uses a COD heater only for the purpose of increasing the temperature of the fuel cell stack, which reduces the utilization of the COD heater, and requires the use of a high-voltage positive temperature coefficient (PTC) heater to assist in heating the vehicle interior, which increases the overall manufacturing cost and power consumption.

The above information disclosed in this Background section is only for enhancement of understanding of the background of the disclosure, and therefore it may contain information that does not form the prior art that is already known in this country to a person of ordinary skill in the art.

### SUMMARY

An embodiment of the present disclosure provides a thermal management system for a fuel cell electric vehicle capable of improving the utilization of a cathode oxygen depletion (COD) heater, and reducing the manufacturing cost by applying a low-voltage PTC heater, by continuously using a cathode oxygen depletion heater applied in order to heat the coolant supplied to a fuel cell stack for heating of the vehicle interior.

A thermal management system for a fuel cell electric vehicle may include a stack cooling apparatus including a first coolant line through which a coolant flows, and a fuel cell stack, a radiator, and a water pump provided on the first coolant line, a heating, ventilation, and air conditioning (HVAC) module inside which a heater core selectively supplied with a high-temperature coolant provided, and a second coolant line connected to the first coolant line to selectively flow the coolant, and provided with the heater core, where the stack cooling apparatus may further include a COD heater, and where the COD heater may be provided on the second coolant line on an upstream side of the heater core.

The stack cooling apparatus may further include a first valve provided on the first coolant line on a downstream side of the water pump, and connected to a first end of the second coolant line, and a second valve provided on the first coolant line on an upstream side of the water pump, and connected to a second end of the second coolant line.

The first valve may be a 3-way valve capable of controlling flow rate distribution and flowing movement of the coolant.

The second valve may be a 4-way valve capable of controlling flow rate distribution and flowing movement of the coolant.

The stack cooling apparatus may further include a third coolant line having a first end connected to the second valve, and a second end connected to the first coolant line between the fuel cell stack and the radiator.

When increasing a temperature of the coolant at the time of initial starting, the first valve may be configured to open a portion of the first coolant line connecting the second valve from the first valve, and close a portion of the first coolant line connecting the first valve to a second end of the third coolant line via the fuel cell stack.

When heating a vehicle interior, the first valve may be configured to open a portion of the first coolant line connecting the second valve from the first valve, and a portion of the first coolant line connecting the first valve to a second end of the third coolant line via the fuel cell stack, respectively.

When increasing a temperature of the coolant at the time of initial starting, or when heating a vehicle interior, the second valve may be configured to open the third coolant line, and close a portion of the first coolant line connecting the second valve to a second end of the third coolant line via the radiator.

When increasing a temperature of the coolant at the time of initial starting, or when heating a vehicle interior, the second coolant line may be opened by the first valve and the second valve.

The HVAC module may further include an air heater.

The air heater may be a low-voltage PTC heater.

When heating a vehicle interior, the COD heater may be operated according to a COD power demand.

The COD power demand may be determined through Equation 1 below,

$$P = \frac{( T 1 - T 2 ) \times Q}{C} \qquad ( Equation 1 )$$

where P is a COD power demand, T1 is a target coolant temperature, T2 is an inlet coolant temperature of the COD heater, Q is a coolant flow rate, and C is a coolant specific heat.

The COD heater may be connected in series with the heater core through the second coolant line.

As described above, according to a thermal management system for a fuel cell electric vehicle according to an embodiment, by continuously using a cathode oxygen depletion heater applied in order to heat the coolant supplied to a fuel cell stack for heating of the vehicle interior, the utilization of a COD heater may be improved.

In addition, according to the use of the COD heater for heating of the vehicle interior, an embodiment may apply low-voltage PTC heater instead of the high-voltage PTC heater that was conventionally applied to assist heating of the vehicle interior, thereby reducing the overall manufacturing cost.

In addition, an embodiment may determine a target coolant temperature according to an ambient air temperature, a set temperature of the vehicle interior, and the amount of heat that can be dissipated by a heater core, and calculate and apply the electric power demand required for an optimal operation of the COD heater by using the temperature and flow rate of the coolant introduced into the COD heater, so as to improve the overall electric cost (cost incurred by using electricity), and reduce the power consumption.

In addition, an embodiment may maintain an operation temperature of the fuel cell stack at an optimal state through the optimal control of the COD heater, thereby maintaining the efficiency and durability of the fuel cell stack at a best condition, and improving the overall marketability of the vehicle.

### BRIEF DESCRIPTION OF THE DRAWINGS

FIG. 1 is a block diagram of a thermal management system for a fuel cell electric vehicle according to an embodiment.

FIG. 2 is an operation diagram according to an initial starting of a vehicle in a thermal management system for a fuel cell electric vehicle according to an embodiment.

FIG. 3 is an operation diagram according to heating of a vehicle interior in a thermal management system for a fuel cell electric vehicle according to an embodiment.

### DETAILED DESCRIPTION OF ILLUSTRATIVE EMBODIMENTS

An embodiment will hereinafter be described in detail with reference to the accompanying drawings.

Exemplary embodiments disclosed in the present specification and the constructions depicted in the drawings are only embodiments of the present disclosure, and do not cover the entire scope of the present disclosure. Therefore, it will be understood that there may be various equivalents and variations at the time of the application of this specification.

In order to clarify the present disclosure, parts that are not related to the description will be omitted, and the same elements or equivalents are referred to with the same reference numerals throughout the specification.

Also, the size and thickness of each element are arbitrarily shown in the drawings, but the present disclosure is not necessarily limited thereto, and in the drawings, the thickness of layers, films, panels, regions, etc., are exaggerated for clarity.

In addition, unless explicitly described to the contrary, the word “comprise” and variations such as “comprises” or “comprising”, will be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation.

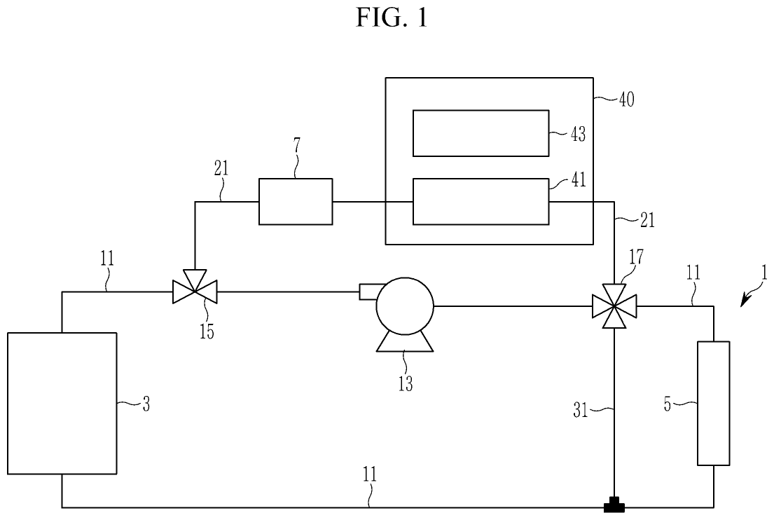

FIG. 1 is a block diagram of a thermal management system for a vehicle according to an embodiment.

Referring to FIG. 1, a thermal management system for a fuel cell electric vehicle according to an embodiment may continuously use, for heating of a vehicle interior, a cathode oxygen depletion heater 7 (hereinafter, referred to as a ‘COD heater’) applied in order to heat a coolant supplied to a fuel cell stack 3, so as to improve utilization of a COD heater 7, and reduce the manufacturing cost by applying a low-voltage PTC heater.

Such a thermal management system may include a stack cooling apparatus 1, a second coolant line 21, and a HVAC module 40.

First, the stack cooling apparatus 1 may include a first coolant line 11 through which the coolant circulates. The fuel cell stack 3, a radiator 5, and a water pump 13 may be provided on the first coolant line 11.

The radiator 5 may be disposed at the front of the vehicle. A cooling fan 6 may be provided at the rear of the radiator 5. Accordingly, the radiator 5 may cool the coolant through an operation of the cooling fan (not shown) and heat-exchange with an ambient air.

The stack cooling apparatus 1 configured as such may cool the fuel cell stack 3 by using the coolant cooled at the radiator 5.

In an embodiment, the second coolant line 21 may be connected to the first coolant line 11, so that the coolant may selectively flow therethrough.

A heater core 41 selectively supplied with a high-temperature coolant may be provided inside the HVAC module 40. Here, the heater core 41 may be provided on the second coolant line 21.

That is, the heater core 41 may heat the vehicle interior by using the selectively introduced high-temperature coolant. The heater core 41 may be an air-cooled heat-exchanger that heat-exchanges the high-temperature coolant and the ambient air with each other.

In an embodiment, the stack cooling apparatus 1 may further include the COD heater 7. The COD heater 7 may be a core component part responsible for improving the performance, ensuring durability, and providing safety functions of the fuel cell stack 3.

The COD heater 7 may rapidly heat the coolant and supply the heated coolant to the fuel cell stack 3 in an initial stage of starting the vehicle in an environment of a low temperature, so as to increase the fuel cell stack 3 to an appropriate operation temperature.

In an embodiment, the COD heater 7 may be provided on the second coolant line 21 on an upstream side of the heater core 41.

Here, the COD heater 7 may be connected in series with the heater core 41 through the second coolant line 21.

On the other hand, the upstream side of the heater core 41 may be set based on a flow direction of the coolant.

Based on the direction in which the coolant flows along the second coolant line 21, a position where the coolant is introduced into the heater core 41 may be defined as the upstream side of the heater core 41, and a position where the coolant is discharged from the heater core 41 may be defined as a downstream side of the heater core 41.

Here, the stack cooling apparatus 1 may further include a first valve 15, a second valve 17, and a third coolant line 31.

First, the first valve 15 may be provided on the first coolant line 11 on a downstream side of the water pump 13. A first end of the second coolant line 21 may be connected to the first valve 15.

Here, the first valve 15 may be a 3-way valve capable of controlling flow rate distribution and flowing movement of the coolant.

The second valve 17 may be provided on the first coolant line 11 on an upstream side of the water pump 13. A second end of the second coolant line 21 may be connected to the second valve 17.

Here, the second valve 17 may be a 4-way valve capable of controlling flow rate distribution and flowing movement of the coolant.

On the other hand, in an embodiment, the upstream side and the downstream side of the water pump 13 may be set based on the flow direction of the coolant.

That is, based on the direction in which the coolant flows along the first coolant line 11, a position where the coolant is introduced into the water pump 13 may be defined as the upstream side of the water pump 13, and a position where the coolant is discharged from the water pump 13 may be defined as the downstream side of the water pump 13.

In addition, a first end of the third coolant line 31 may be connected to the second valve 17. A second end of the third coolant line 31 may be connected to the first coolant line 11 between the fuel cell stack 3 and the radiator 5.

In the stack cooling apparatus 1 configured as described above, when increasing a temperature of the coolant at the time of initial starting, the first valve 15 may open a portion of the first coolant line 11 connecting the first valve 15 to the second valve 17 via the water pump 13.

Simultaneously, the first valve 15 may close a portion of the first coolant line 11 connecting the first valve 15 to the second end of the third coolant line 31 via the fuel cell stack 3.

In addition, when heating the vehicle interior, the first valve 15 may open a portion of the first coolant line 11 connecting the first valve 15 to the second valve 17 via the water pump 13, and a portion of the first coolant line 11 connecting the first valve 15 to the second end of the third coolant line 31 via the fuel cell stack 3, respectively.

In addition, when increasing the temperature of the coolant at the time of initial starting, or when heating the vehicle interior, the second valve 17 may open the third coolant line 31.

Simultaneously, the second valve 17 may close a portion of the first coolant line 11 connecting the second valve 17 to the second end of the third coolant line 31 via the radiator 5.

Here, when increasing the temperature of the coolant at the time of initial starting, or when heating the vehicle interior, the second coolant line 21 may be opened by the first valve 15 and the second valve 17.

On the other hand, in an embodiment, the HVAC module 40 may further include an air heater 43. Here, the air heater 43 may be a low-voltage PTC heater having a small power consumption.

The air heater may be disposed in the interior of the HVAC module 40 on a downstream side of the heater core 41 toward the vehicle interior, so as to selectively heat the ambient air having passed through the heater core 41.

On the other hand, in an embodiment, the upstream side and the downstream side of the heater core 41 may be set based on a flow direction of the ambient air.

Based on the direction in which the ambient air flows in the HVAC module 40, a position where the ambient air is introduced into the heater core 41 may be defined as the upstream side of the heater core 41, and a position where the ambient air is discharged from the heater core 41 may be defined as the downstream side of the heater core 41.

On the other hand, although it is illustrated in the drawings as an example that the heater core 41 and the air heater 43 are provided in the HVAC module 40, it is not limited thereto, and a heat-exchanger for cooling the vehicle interior by using a low-temperature refrigerant, or a low-temperature coolant may be further provided.

In the thermal management system configured as described above, when heating the vehicle interior, the COD heater 7 may be operated according to a COD power demand P.

The COD power demand P may be determined through Equation 1 below:

$$P = \frac{( T 1 - T 2 ) \times Q}{C} . \qquad ( Equation 1 )$$

In Equation 1, P may be a COD power demand, T1 may be a target coolant temperature, T2 may be an inlet coolant temperature of the COD heater, Q may be the coolant flow rate, and C may be the coolant specific heat.

Here, the target coolant temperature may be determined by the ambient air temperature and the vehicle interior temperature set by the user. In addition, the coolant specific heat may be determined depending on the type of the coolant.

Accordingly, the COD heater 7 may be operated at the COD power demand P determined by the above Equation, so as to increase the temperature of the coolant only to a temperature at which heat can be dissipated from the HVAC module 40 while maintaining the optimal temperature of the coolant supplied to the fuel cell stack 3.

That is, when heating the vehicle interior, the thermal management system may operate the COD heater 7 at the COD power demand P determined by the above Equation, so as to optimally maintain an operation efficiency of the fuel cell stack 3, and at the same time, use the COD heater 7 for heating of the vehicle interior.

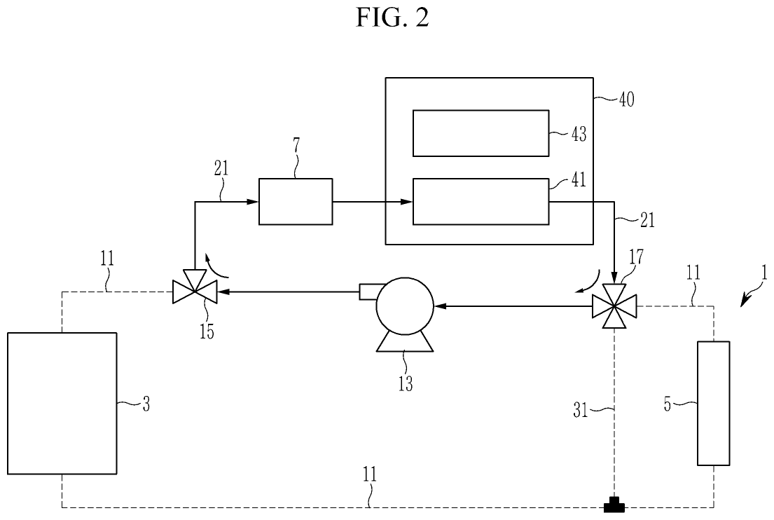

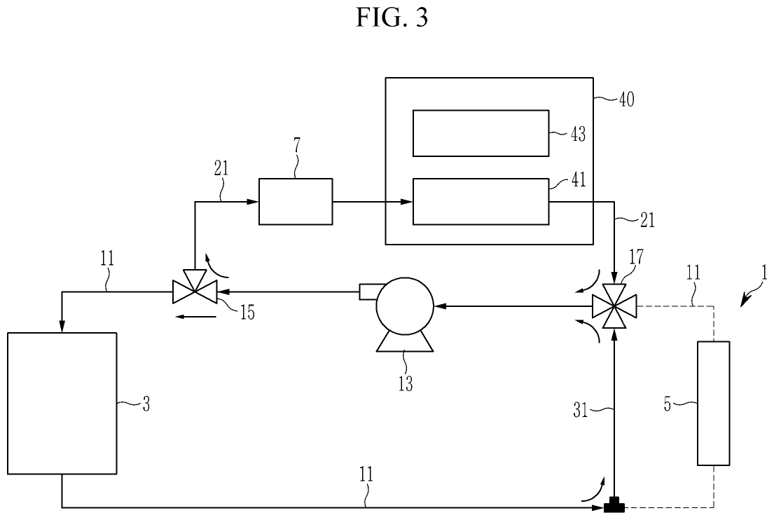

Hereinafter, an operation and action of a thermal management system for a fuel cell electric vehicle according to an embodiment configured as described above will be described in detail with reference to FIG. 2 to FIG. 3.

First, an operation for increasing the temperature of the coolant in an initial stage of starting of the vehicle will be described with reference to FIG. 2.

FIG. 2 is an operation diagram according to the initial stage of starting the vehicle of a thermal management system for a fuel cell electric vehicle according to an embodiment.

Referring to FIG. 2, when the temperature of the coolant is low at the time of the initial stage of starting the vehicle, the first valve 15 may open a portion of the first coolant line 11 connecting the first valve 15 to the second valve 17 via the water pump 13.

In addition, the first valve 15 may close a portion of the first coolant line 11 connecting the first valve 15 to the second end of the third coolant line 31 via the fuel cell stack 3.

The second valve 17 may close a portion of the first coolant line 11 connecting the second valve 17 to the second end of the third coolant line 31 via the radiator 5.

In addition, the second valve 17 may open the third coolant line 31. Accordingly, the coolant may not be supplied to the radiator 5.

In addition, the second coolant line 21 may be opened by the first valve 15 and the second valve 17.

In such a state, when the water pump 13 is operated, the coolant may flow along the opened portion of first coolant line 11 and the second coolant line 21.

At this time, the COD heater 7 may heat the coolant introduced from the first valve 15 through the second coolant line 21 to an optimal operation temperature of the fuel cell stack 3.

In addition, an operation for heating the vehicle interior will be described with reference to FIG. 3.

FIG. 3 is an operation diagram according to a heating of the vehicle interior of a thermal management system for a fuel cell electric vehicle according to an embodiment.

Referring to FIG. 3, when heating the vehicle interior, the first valve 15 may open a portion of the first coolant line 11 connecting the first valve 15 to the second valve 17 via the water pump 13.

In addition, the first valve 15 may open a portion of the first coolant line 11 connecting the first valve 15 to the second end of the third coolant line 31 via the fuel cell stack 3.

The second valve 17 may close a portion of the first coolant line 11 connecting the second valve 17 to the second end of the third coolant line 31 via the radiator 5.

In addition, the second valve 17 may open the third coolant line 31. Accordingly, the coolant may not be supplied to the radiator 5.

In addition, the second coolant line 21 may be opened by the first valve 15 and the second valve 17.

In such a state, when the water pump 13 is operated, a portion of coolant among the coolant discharged from the water pump 13 and introduced into the first valve 15 may be supplied to the COD heater 7 along the second coolant line 21.

At this time, the COD heater 7 may be operated at the COD power demand P determined by the above Equation 1, so as to increase the temperature of the coolant only to a temperature at which heat can be dissipated from the HVAC module 40.

The coolant heated at the COD heater 7 may be cooled to an optimal operation temperature of the fuel cell stack 3 through heat-exchange with the ambient air while passing through the heater core 41.

Here, the air heater 43 may be selectively operated when the ambient air having passed through the heater core 41 is lower than the target temperature set by the user.

The coolant having passed through the heater core 41 may be introduced into the second valve 17 along the second coolant line 21.

On the other hand, a remaining coolant among the coolant discharged from the water pump 13 and introduced into the first valve 15 may be supplied to the fuel cell stack 3 along the first coolant line 11.

The coolant having passed through the fuel cell stack 3 may flow through the opened portion of the first coolant line 11, and then flow through the third coolant line 31.

Then, the coolant having flown through the third coolant line 31 may be introduced into the second valve 17.

Through such an operation, the coolant may be respectively introduced into the second valve 17 through the first coolant line 11 and the second coolant line 21.

Each coolant introduced into the second valve 17 may be introduced into the water pump 13 along the first coolant line 11 from the second valve 17, thereby repeatedly performing the above-described processes.

That is, the thermal management system may use the COD heater 7 not only for maintaining the temperature of the fuel cell stack 3, but also use it for heating the vehicle interior, thereby reducing the usage of the air heater 43, and improving the overall heating performance.

Therefore, according to a thermal management system for a fuel cell electric vehicle according to an embodiment configured as described above, the COD heater 7 applied in order to heat the coolant supplied to the fuel cell stack may be continuously used for heating of the vehicle interior, so as to improve the utilization of the COD heater 7.

In addition, according to the use of the COD heater 7 for heating of the vehicle interior, an embodiment may apply the air heater 43, as the low-voltage PTC heater, instead of the conventional high-voltage PTC heater that was applied to assist heating of the vehicle interior, thereby reducing the overall manufacturing cost.

In addition, an embodiment may determine a target coolant temperature according to the ambient air temperature, the set temperature of the vehicle interior, and the amount of heat that can be dissipated by the heater core 41, and calculate and apply the COD power demand P required for an optimal operation of the COD heater 7 by using the temperature and flow rate of the coolant introduced into the COD heater 7, so as to improve the overall electric cost (cost incurred by using electricity), and reduce the power consumption.

In addition, an embodiment may maintain an operation temperature of the fuel cell stack 3 at an optimal state through the optimal control of the COD heater 7, thereby maintaining the efficiency and durability of the fuel cell stack 3 at a best condition, and improving the overall marketability of the vehicle.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A thermal management system comprising:
a first coolant line through which a coolant is flowable;
a fuel cell stack, a radiator, and a water pump provided on the first coolant line;
a HVAC module comprising a heater core configured to be selectively supplied with a coolant;
a second coolant line connected to the first coolant line to selectively provide the coolant to the heater core, the heater core being provided on the second coolant line; and
a cathode oxygen depletion (COD) heater provided on the second coolant line on an upstream side of the heater core.

2. The thermal management system of claim 1, further comprising:
a first valve provided on the first coolant line on a downstream side of the water pump, and connected to a first end of the second coolant line; and
a second valve provided on the first coolant line on an upstream side of the water pump, and connected to a second end of the second coolant line.

3. The thermal management system of claim 2, wherein the first valve is a 3-way valve configured to control flow rate distribution and flow direction of the coolant.

4. The thermal management system of claim 2, wherein the second valve is a 4-way valve configured to control flow rate distribution and flow direction of the coolant.

5. The thermal management system of claim 2, further comprising a third coolant line comprising a first end connected to the second valve, and a second end connected to the first coolant line between the fuel cell stack and the radiator.

6. The thermal management system of claim 5, wherein, in response to increasing a temperature of the coolant at initial starting, the first valve is configured to:
open a portion of the first coolant line connecting the first valve to the second valve; and
close a portion of the first coolant line connecting the first valve to a second end of the third coolant line via the fuel cell stack.

7. The thermal management system of claim 5, wherein, in response to heating a vehicle interior, the first valve is configured to:
open a portion of the first coolant line connecting the first valve to the second valve; and
open a portion of the first coolant line connecting the first valve to a second end of the third coolant line via the fuel cell stack.

8. The thermal management system of claim 5, wherein, in response to increasing a temperature of the coolant at initial starting, or in response to heating a vehicle interior, the second valve is configured to:
open the third coolant line; and
close a portion of the first coolant line connecting the second valve to a second end of the third coolant line via the radiator.

9. The thermal management system of claim 2, wherein, in response to increasing a temperature of the coolant at initial starting or heating a vehicle interior, the second coolant line is opened by the first valve and the second valve.

10. The thermal management system of claim 1, wherein the HVAC module further comprises an air heater.

11. The thermal management system of claim 10, wherein the air heater is a low-voltage positive temperature coefficient (PTC) heater.

12. The thermal management system of claim 1, wherein, in response to heating a vehicle interior, the COD heater is operated according to a COD power demand.

13. The thermal management system of claim 12,
wherein the COD power demand is determined based on the equation:
$$P = \frac{( T 1 - T 2 ) \times Q}{C} ,$$
wherein P is the COD power demand, T1 is a target coolant temperature, T2 is an inlet coolant temperature of the COD heater, Q is a coolant flow rate, and C is a coolant specific heat.

14. The thermal management system of claim 1, wherein the COD heater is connected in series with the heater core through the second coolant line.

15. A method for controlling a coolant temperature, the method comprising:
operating a water pump to circulate a coolant through a first coolant line;
opening, by a first valve provided on the first coolant line, a portion of the first coolant line connecting the first valve to a second valve;
closing, by the first valve, a portion of the first coolant line connecting the first valve to a fuel cell stack;
flowing the coolant through a second coolant line connected between the first valve and the second valve; and
heating the coolant by operating a cathode oxygen depletion (COD) heater provided on the second coolant line.

16. The method of claim 15, further comprising:
opening, by the second valve, a third coolant line connecting the second valve to the first coolant line between the fuel cell stack and a radiator; and
closing, by the second valve, a portion of the first coolant line connecting the second valve to the radiator.

17. The method of claim 15, wherein the coolant is heated during initial starting to increase a temperature of the fuel cell stack to an optimal operating temperature.

18. A method for controlling a vehicle interior temperature, the method comprising:
circulating a coolant through a first coolant line provided with a fuel cell stack, a radiator, and a water pump;
flowing at least a portion of the coolant through a second coolant line connected to the first coolant line;
heating the coolant by operating a cathode oxygen depletion (COD) heater provided on the second coolant line; and
heating a vehicle interior by heat-exchanging the coolant with ambient air through a heater core provided on the second coolant line on a downstream side of the COD heater.

19. The method of claim 18, further comprising bypassing the radiator by:
opening, by a second valve provided on the first coolant line, a third coolant line connecting the second valve to the first coolant line between the fuel cell stack and the radiator; and
closing, by the second valve, a portion of the first coolant line connecting the second valve to the radiator.

20. The method of claim 18, wherein the COD heater is operated according to a COD power demand determined based on the equation:
$$P = \frac{( T 1 - T 2 ) \times Q}{C} ,$$
wherein P is the COD power demand, T1 is a target coolant temperature, T2 is an inlet coolant temperature of the COD heater, Q is a coolant flow rate, and C is a coolant specific heat.
